(19) United States
(12) Patent Application Publication
(10) Pub. No.: US 2001/0048971 A1
(43) Pub. Date: Dec. 6, 2001

(54) METHOD OF PRODUCING A POROUS CERAMIC WITH A ZEOLITE COATING

(76) Inventors: SRIDHAR KOMARNENI, STATE COLLEGE, PA (US); HIROAKI KATSUKI, NAGASAKI-KEN (JP); SACHIKO FURUTA, SAGA-KEN (JP)

Correspondence Address: INTELLECTUAL PROPERTY OFFICE, THE PENNSYLVANIA STATE UNIVERSITY, 113 TECHNOLOGY CENTER, UNIVERSITY PARK, PA, 16802

(21) Appl. No.: 08/931,968

(22) Filed: Sep. 17, 1997

(51) Int. Cl. B05D 3/02; B01J 29/06

(52) U.S. Cl. 427/226; 427/553; 427/399; 427/376.3; 427/385.5; 502/439; 502/64; 502/71

(57) ABSTRACT

The present invention provides a method for manufacturing zeolite which is useful as catalyst carrier for exhaust gas clean up by decomposition, reduction or oxidation catalyst carrier for synthesis and/or decomposition of organic or inorganic chemicals, and membrane for selective separation of organic substances, gases and inorganic cations. This new method is one in which a crystalline silica or amorphous glass contained in a fired ceramic substrate is used as a silica source for forming a natural or synthetic zeolite film on the ceramic substrate, while at the same time making the ceramic substrate porous.

### BACKGROUND

Known methods of manufacturing a zeolite useful as a catalyst carrier are known as follows. One method is the forming of a high silica-content zeolite film from a material such as silicalite or ZSM-5 on a ceramic porous carrier. The ceramic porous carrier is usually of a material such as alumina, mullite, cordierite or glass. An aqueous solution containing water glass or colloidal silica as a silica source for the zeolite is added with tetrapropyl-ammonium-bromide TPABr (for controlling the skeleton structure of the zeolite) and an inorganic salt (such as NaOH) to form a hydrated gel that is aged. Then, the porous ceramics and the hydrated gel are subjected to a hydrothermal treatment to form a zeolite film directly on the surface of the porous ceramics. The use of this aqueous gel for the preparation of the zeolite film leads to the following disadvantages. It is difficult to form a compact layer of zeolite on the surface of ceramic porous substrate without forming pin holes because of complex stirring treatment operation; it is difficult to form a zeolite film with an even thickness; the adhesion strength of the zeolite film to the porous ceramic is relatively low; it takes as long as several days to tens of days to form the zeolite film; and the preparation of the gel with homogeneous composition is a difficult task.

Another method is taking a porous ceramic arid dipping it in a suspension containing zeolite powder, where the ceramic is then dried so that a zeolite film forms on the ceramic. However, this method has the disadvantages that the adhesion strength of the zeolite film to the porous ceramic is relatively low. Yet, another method is when various catalyst carriers are manufactured using natural zeolite or a synthesized zeolite powder. The zeolite porous materials are prepared by molding the zeolite powder in a form of a pellet, pipe, honeycomb, or sheet followed by a calcination process at a temperature of 600 to 1000° C. However, the zeolite carriers formed by this method have low mechanical strength and poor porous characteristics when the zeolites are calcined at the temperature of 600 to 1000° C. There is a method for improving the mechanical strength of the calcined zeolite by adding a glassy phase for the promotion of sinetrring, but this method also leads to poor porous characteristics.

It is the objective of this invention to provide a method of producing a porous ceramic with a zeolite coating that has excellent adhesion strength, heat resistance, and porous characteristics.

### SUMMARY OF THE INVENTION

The present invention is a method for producing a porous ceramic with a zeolite coating. Materials are sintered to create a ceramic substrate. These material should include mullite and a silica source to form a zeolite. The source is usually a silica or amorphous glass. The substrate is mixed in a solution which is capable of dissolving the silica source to form the zeolite. This mixture is then heated to form a zeolite coating on the ceramic substrate, while at the same time dissolving the silica source in order to form a porous ceramic.

### BRIEF DESCRIPTION OF THE DRAWINGS

FIG. 1 is a porous ceramic with a zeolite coating which was produced with the method according to the present invention;

FIG. 2 is a magnified view of FIG. 1;

FIG. 3 is a magnified view of FIG. 2; and

FIG. 4 is a magnified view of FIG. 3.

### DETAILED DESCRIPTION

The present invention provides a method for manufacturing a high silica-content zeolite film on the surface of a ceramic substrate using a natural zeolite or synthetic zeolite (such as silicalite, ZSM-5, aluminosilicates, aluminosilico phosphates, aluminophosphates, metal aluminophosphates, gallophosphates, or ironphosphates molecular sieve). This new method is one in which a crystalline silica or amorphous glass contained in a fired ceramic substrate is used as a silica source for forming a natural or synthetic zeolite film on the ceramic substrate, while at the same time making the ceramic substrate porous.

Raw materials are chosen for making the ceramic substrate that contain natural silicate minerals to use as a silica source for the zeolite film. A combination of silica and alumina powders along with or without other chemical additives is molded in various shapes to form the ceramic substrate. The molded shape is then sintered at 1000 to 1700° C. to create the ceramic substrate. The results are a fired body of mullite; and quartz, cristobalite, tridymite, or amorphous glass. The composition of the resulting fired body depends on the type of silicate mineral; mixture composition ratio of silica and alumina powder with other chemicals; and the firing temperature. Depending on the firing temperature and type of raw materials, the mullite is in the form of a needle-like crystal, whisker-like crystal, column-like crystal, or particulate-like crystal.

Generally, quartz, cristobalite, tridymite, and amorphous glass are dissolved easily in an aqueous alkali solution. On the contrary, mullite is not easily dissolved. Utilizing this solubility difference, the fired substrate is then subjected to a hydrothermal treatment at 100 to 250° C. together with an inorganic or organic base such as sodium hydroxide, potassium hydroxide, calcium hydroxide, ammonium hydroxide, lithium hydroxide, alkyl ammonium hydroxides or mixtures thereof, water; and tetrapropyl-ammonium-bromide TPABr. The hydrothermal treatment is usually performed under pressure of at least saturated steam pressure. Utilizing the reaction of the dissolution and re-crystallization of quartz, cristobalite, tridymite, or amorphous glass in the above described aqueous alkali solution, a porous ceramic having a zeolite film on its surface is obtained. This occurs because the silica source of the ceramic substrate is dissolved when it is subjected to the above hydrothermal treatment with the alkali hydroxide solution. Therefore, the ceramic substrate becomes porous and coated with a zeolite film at the same time, thus producing a new porous composite ceramic material that has a porous structure with nano-size to micro-size pores. The zeolite film formed by this method can have an even or varying thickness along with or without cracks and pin holes.

When a composite porous ceramic such as this is formed, the adhering strength between the surface of porous ceramic and zeolite film is improved because the zeolite film has penetrated and bonded to the structure of the ceramic substrate. This provides a porous material with excellent bending strength and compressive strength. There is a wide range of zeolites available for use as catalyst carriers that can be synthesized using this method. These synthesized zeolites include not only the high silica-content silicalite, but also a zeolite which contains alumina partially eluted from the fired slilicate mineral and an added alkaline earth oxide and/or an alkali oxide (such as aluminosilicate with a SiO₂/Al₂0₃ ratio of 2 to 300). These zeolites can be formed on the substrate by varying the hydrothermal treatment conditions such as organic template, chemical composition, temperature, time, and concentration of alkali hydroxide for the hydrothermal reaction. The thickness and morphology of zeolite film on the porous materials can be controlled by the addition of colloidal silica, silica glass powder or water glass during the hydrothermal treatment.

Therefore, the present invention is a method where an inexpensive fired material of a silicate mineral or a mixture of silica and alumina powder are used. Utilizing the solubility difference in aqueous alkali solution between mullite and quartz, cristobalite, tridymite, or amorphous glass, a zeolite film is formed on the ceramic substrate which becomes porous due to the hydrothermal treatment. The quartz or cristobalite or tridymite may also co-exist in the fired substrate in addition to amorphous glass. Accordingly, it becomes possible to manufacture a new porous ceramic material having a zeolite film on the surface of porous material with excellent adhesion strength, heat resistance, and porous characteristics in comparison with prior methods. The following are general examples and ranges using the method of the present invention which provided favorable results.

### EXAMPLE 1

Generally, it was found that sericite, kaolin, sillimanite, andalusite, or clay mineral commonly used for pottery or refractories could be molded in any shape or form, such as a pipe, disc or honeycomb, etc. This shape is then fired at 1300 to 1700° C. for 2 hours to convert it to a ceramic substrate containing needle-like mullite form or columnar mullite form and amorphous glass. Then a mixture containing amorphous glass (silica source from the substrate), sodium hydroxide, water, and tetrapropyl-ammonium bromide, having a general molar ratio in the range of 50 to 150:10 to 70:2800:5 respectively, was subjected to a hydrothermal treatment in the range of 150 to 350° C. for 2 to 30 days. This produced a porous ceramic with a zeolite film on its surface.

More specifically, the hydrothermal treatment was applied to different ceramic substrates mentioned above in this example along with a mixture having the molar ratio of 100:50:2800:5 at 180° C. for 4 to 16 days. This resulted in a silica rich ZSM-5 film or silicalite film, each having a thickness of 25 to 800 μm and the specific surface area of 220 to 420 m²/g formed on the surface of porous substrate of the needle-like or columnar-like mullite form.

When a ceramic substrate of any of the materials mentioned above and a mixture having the molar ratio of 100:25:2800:5 was subjected to the hydrothermal treatment of 150 to 210° C. for 4 to 25 days, a zeolite film was deposited containing 0.5 to 8 wt % Na₂O with a SiO₂/Al₂0₃ ratio of 20 to 250 and a specific surface area of 50 to 370 m²/g. The porosity of the porous mullite having needle-like or columnar-like mullite was found to be 30 to 60% and the pore size was 0.1 to 2.0 μm.

### EXAMPLE 2

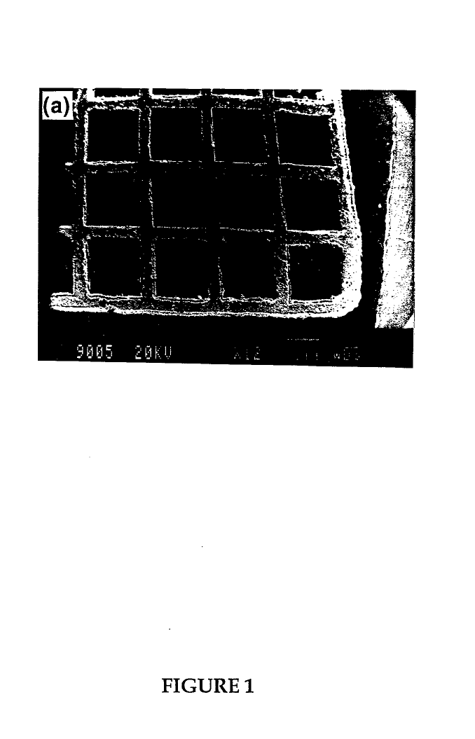

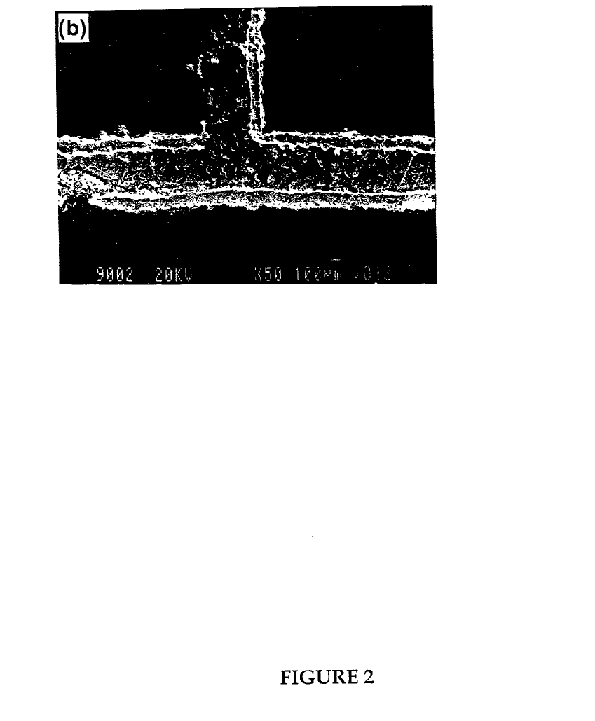

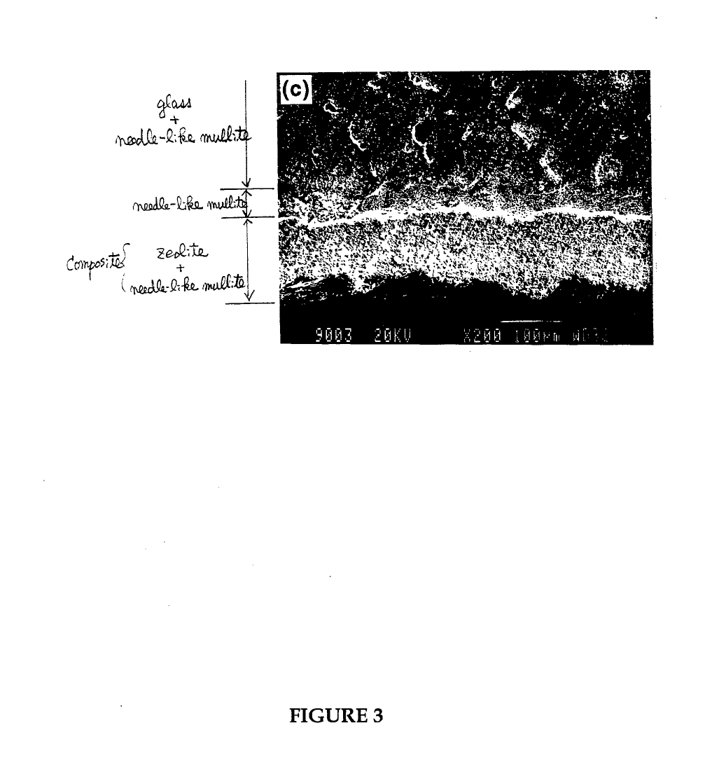

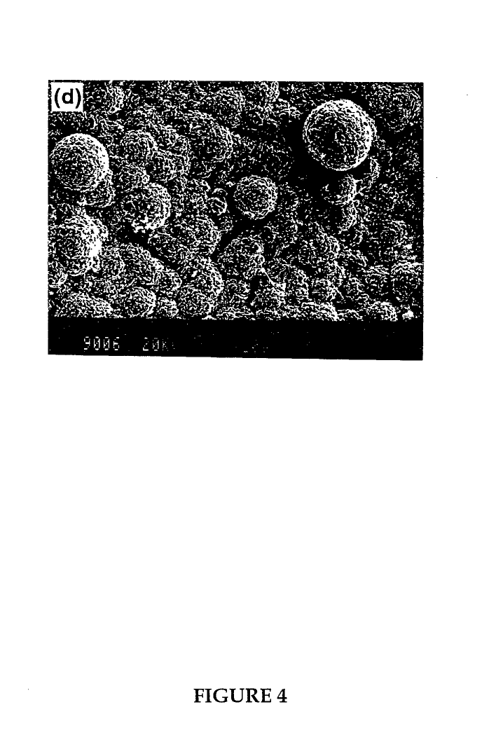

Kaolin honeycombs fired at 1650° C. were subjected to a hydrothermal treatment of 180° C. for 2 days with mixtures having the general molar ratio in the range of Example 1 and additionally included a colloidal silica aqueous solution having a solid content of 20% in an amount of 50 to 200% by weight to amorphous glass. This produced a silicalite film formed on the surface of the porous mullite with a thickness of 300 to 350 μm. It was found that by increasing the treatment time of the hydrothermal treatment, that the thickness of silicalite film was increased on the ceramic substrate. FIGS. 1-4 are photographs which illustrate the fractured surfaces of a New Zealand kaolin honeycomb fired at 1650° C. for 2 hours and then treated with the hydrothermal treatment. The hydrothermal treatment was performed at 190° C. for 7 days. The mixture used in the hydrothermal treatment had the molar ratio of 100(SiO₂):25.5(NaOH):2800(water):5(TPABr). FIGS. 1-4 are of increasing magnification of the ceramic with a zeolite film, where the magnification is as specified in each figure. FIG. 3 indicates the specific components of the ceramic.

### EXAMPLE 3

A molded composite having silica powder and alumina powder in a ratio by weight of 70 to 90:20 to 40 was fired at 1300 to 1700° C. for 2 hours to form a ceramic substrate containing needle-like or columnar-like mullite and amorphous glass. The same hydrothermal treatment with the mixture having the general molar ratio range as described in Example 1 was carried out and produced a silicalite or zeolite film with a SiO₂/Al₂0₃ ratio of 1 to 250. In this case, the porosity and the pore size of porous mullite comprising needle-like or columnar-like mullite were 20 to 60% and 0.1 to 3 μm, respectively. On the other hand, when the zeolite film was calcined at 500° C. for 13 hours it produced a specific surface area of 140 to 460 m²/g and a pore size of 0.2 to 2.5 nm.

### EXAMPLE 4

The adhesion strength and compressive strength of zeolite film with a thickness of 200 μm, deposited on the surface of porous mullite accordingly to Example 1 were both measured. The adhesion strength measured 150 to 210 kgf/cm² and the compressive strength measured 650 to 700 kgf/cm². After a composite porous ceramic having a zeolite film with a thickness of 200 μm and porous composition of needle-like mullite was heated at 900° C. for 60 hours, the porous characteristics were measured and found to be the following. The specific surface area was 150 to 210 m₂/g and there were no cracks and pin holes. Thereby showing that the composite porous material such as zeolite/mullite and silicalite/mullite using the method of the present invention has excellent heat resistance.

It is believed that the growing speed of the zeolite film can be accelerated 5 to 20 times by applying irradiation of microwaves, ultrasonic waves or an electric field during the hydrothermal treatment at 100 to 350° C. It is especially believed that if the hydrothermal treatments as described in Examples 1 and 2 were carried out in the range of 100-195° C. under irradiation of a microwave with a frequency of 2.45 GHz (600 W), the same silicalite or zeolite film obtained in Examples 1 and 2 would be formed in a shorter treatment time. This time could be as short as 2 to 6 hours, making the deposition speed of the film faster than that by normal hydrothermal treatment of Examples 1 and 2.

While different embodiments of the invention has been described in detail herein, it will be appreciated by those skilled in the art that various modifications and alternatives to the embodiment could be developed in light of the overall teachings of the disclosure. Accordingly, the particular arrangements are illustrative only and are not limiting as to the scope of the invention which is to be given the full breadth of the appended claims and any and all equivalents thereof.

We claim:

1. A method of producing a porous ceramic with a zeolite coating, comprising the steps of:
(a) sintering materials to create a ceramic substrate, in which the materials to be sintered include mullite and a source to form a zeolite;
(b) mixing the ceramic substrate in a solution which is capable of dissolving the source to form the zeolite; and
(c) heating the mixture of step (b) to form a zeolite coating on the ceramic substrate, while dissolving the source used to form the zeolite.

2. The method of claim 1, wherein the source to form the zeolite is a silica material.

3. The method of claim 2, wherein the solution is an aqueous alkali solution.

4. The method of claim 3, wherein the aqueous alkali solution includes a base, water and tetrapropyl-ammonium bromide.

5. The method of claim 4, wherein the molar ratio range of the source:base:water:tetrapropyl-ammonium bromide is respectively 50 to 150:10 to 70:2800:5.

6. The method of claim 5, wherein the base is at least one of the following: sodium hydroxide, potassium hydroxide, calcium hydroxide, ammonium hydroxide, lithium hydroxide, alkyl ammonium hydroxide.

7. The method of claim 1, wherein the heating of step (c) is performed at 100 to 350° C. for 1 to 30 days.

8. The method of claim 1, wherein the heating of step (c) is conducted under at least saturated steam pressure.

9. The method of claim 1, wherein the materials of step (a) are sintered at 1000 to 1700° C.

10. The method of claim 1, wherein the source of step (a) is at least one of the following: quartz, cristobalite, tridymite, amorphous glass.

11. The method of claim 1, wherein the materials of step (a) include a combination of silica powder and alumina powder.

12. The method of claim 11, wherein an alkaline earth oxide is added to the mixture of step (b) to combine with alumnina partially eluted from the ceramic substrate in order to form the zeolite coating.

13. The method of claim 11, wherein an alkali oxide is added to the mixture of step (b) to combine with alumnina partially eluted from the ceramic substrate in order to form the zeolite coating.

14. The method of claim 13, wherein the alkali oxide is aluminosilicate (SiO₂/Al₂0₃).

15. The method of claim 1, wherein at least one of the following is added to the mixture in step (b): colloidal silica, silica glass powder, water glass.

16. The method of claim 1, wherein at least one of the following is part of the materials used in step (a): sericite, kaolin, sillimanite, andalusite, pottery clay.

17. The method of claim 1, wherein the time to form the zeolite coating of step (c) is accelerated by applying irradiation of microwaves.

18. A porous ceramic with a zeolite coating by the process of sintering materials to create a ceramic substrate, in which the materials to be sintered include mullite and a source to form a zeolite; mixing the ceramic substrate in a solution which is capable of dissolving the source to form the zeolite; and heating the substrate and solution to form a zeolite coating on the ceramic substrate, while dissolving the source used to form the zeolite.

19. The porous ceramic with a zeolite coating of claim 18, wherein the source to form the zeolite is a silica material.

20. The porous ceramic with a zeolite coating of claim 19, wherein the solution is an aqueous alkali solution.
